(19) United States
(12) Patent Application Publication
(10) Pub. No.: US 2008/0134201 A1
(43) Pub. Date: Jun. 5, 2008

(54) Distributed process control and excecution

(76) Inventors: Hans-Ulrich A. von Helmolt, Heidelberg (DE); Thomas A. Mayer, Leimen (DE)

Correspondence Address: SAP/BLAKELY, 1279 OAKMEAD PARKWAY, SUNNYVALE, CA, 94085-4040, US

(21) Appl. No.: 11/607,154

(22) Filed: Dec. 1, 2006

(51) Int. Cl. G06F 13/00; G06F 15/16

(52) U.S. Cl. 719/313; 709/201

(57) ABSTRACT

A system and method for process execution in a distributed system. A central instance creates a generic process definition. A relevant portion of the process definition may be distributed to the various constituents of the system so that each constituent can execute a relevant portion of the process locally at runtime. The results of the local execution may be communicated directly between constituents.

### BACKGROUND OF THE INVENTION

1. Field

Embodiments of the invention relate to control and execution of extended business processes. More specifically, embodiments of the invention relate to central definition and local execution of extended business processes.

2. Background

Historically, extended business processes have often used a centralized instance control the process. This results in a hub and spoke architecture where various constituent processes rely on the central instance for process control and execution at runtime. As the number of instances for which the process must be executed increases and the data volume increases proportionally, central execution and control may become a bottleneck. For example, in the context of fulfillment, various subsystems (constituents) of a supply chain management system rely on aspects of the fulfillment process. For example, the sale subsystem, the planning subsystem, the warehouse management subsystem all rely to some degree on the fulfillment process. In a larger enterprise, each of these subsystems may involve numerous products and/or product locations resulting in a flood of data to the central instance responsible for fulfillment. These subsystem's expectations of substantially real time response to fulfillment requests magnifies the problems caused by the bottleneck in the existing architecture.

### SUMMARY OF THE INVENTION

A system and method for process execution in a distributed system is disclosed. A central instance creates a generic process definition. A relevant portion of the process definition may be distributed to the various constituents of the system so that each constituent can execute a relevant portion of the process locally at runtime. The results of the local execution may be communicated directly between constituents.

### BRIEF DESCRIPTION OF DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of a system according to one embodiment of the invention.

FIG. 1A is an architectural diagram of an instance of a generic constituent in one embodiment of the invention.

FIG. 2 is a block diagram of partial process execution during runtime in one embodiment of the invention.

FIG. 3 shows the view of various constituents in one embodiment of the invention.

FIG. 4 is a flow diagram of operation of system of one embodiments of the invention.

### DETAILED DESCRIPTION

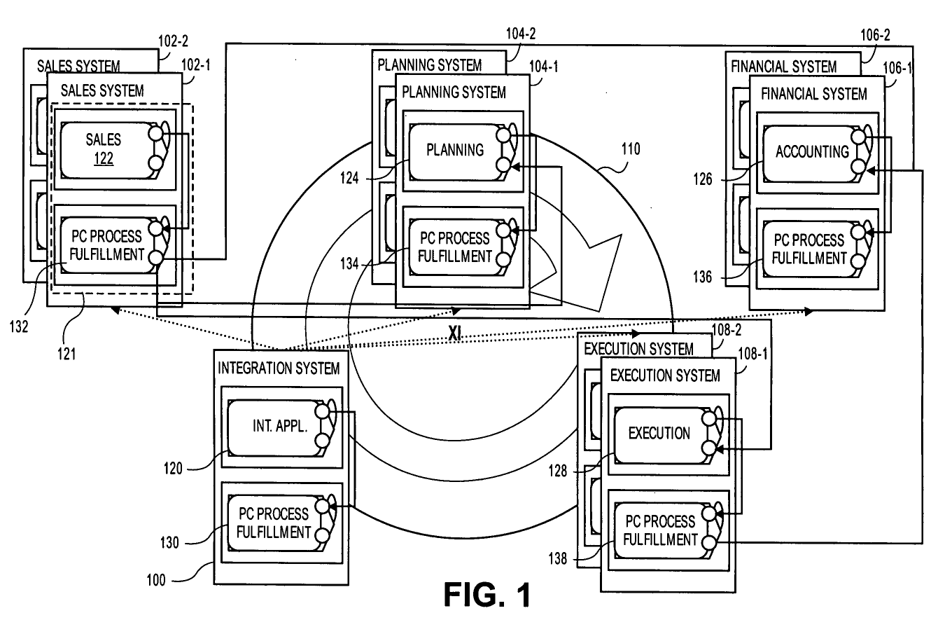

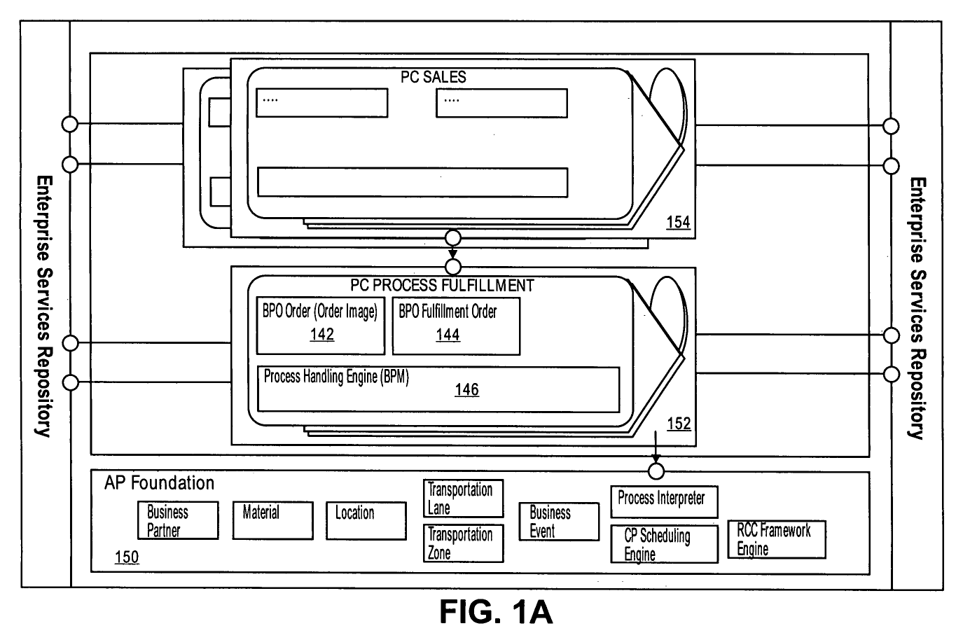

FIG. 1 is a block diagram of a system according to one embodiment of the invention. An integration system 100 includes an integration application process component 120 which defines and maintains a copy of a genericized process such as process component (PC) process fulfillment 130. The integration system uses a messaging protocol to communicate with constituents of a distributed system. In one embodiment, integration system has an interface to exchange infrastructure 110 which provides a messaging protocol for communication amongst constituents of the distributed system. Exchange infrastructure 110 available from SAP AG of Walldorf, Germany permits point to point asynchronous messaging between the system constituents. Other embodiments may use other messaging protocols to communicate between system constituents.

Prior to runtime, the integration system 100 sends a relevant portion of the process definition, here PC process fulfillment, to the various instances of the constituents. This distribution is depicted as the dotted lines between the integration system 100 and the other constituents in FIG. 1. In the shown embodiment, the constituents are sales system 102 (instances 102-1 and 102-2), panning system 104 (instances 104-1 and 104-2), financial system 106 (instances 106-1 and 106-2), and execution system 108 (instances 108-1 and 108-2). These constituents may alternatively be referred to as subsystems or application process components. While two instances of each constituent are depicted, more or fewer instances of each component may exist in various embodiments of the invention.

Each instance 102-1, 102-2 of the sales system 102 includes a sales application component 122 and the sales relevant portion of the genericized process (here process fulfillment 132) distributed by the integration system in advance of runtime). Similarly, the planning system includes a planning application component 124 and the planning relevant portion of the genericized process, PC process fulfillment 134. Financial system 106 includes accounting application component 126 and the financially relevant portion of the genericized process component (PC) process fulfillment 136. Similarly, execution system includes an execution application 128 and the execution relevant portion of process component process fulfillment 138. In other embodiments, more or fewer constituents may exist. While much of the discussion herein illustrates embodiments of the invention in the context of process fulfillment, other processes may be generically defined in advance of runtime and distributed to run locally on distributed constituents in accordance with embodiments of the invention.

At runtime, the constituents communicate directly amongst themselves and execute and the distributed process, here process fulfillment, locally to each constituent. This is depicted as the solid lines between constituents in FIG. 1. Thus, each constituent relevant portion of the process has a constituent centric view of that process. As such, in one embodiment, the integration system 100 which retains a complete view of the entire process definition may perform a monitoring function for the overall distributed system. However, because the process for each instance and each constituent executes locally the bottleneck inherent in a hub and spoke architecture is avoided.

FIG. 1A is an architectural diagram of an instance of a generic constituent in one embodiment of the invention. One or more instances of an application process component interfaced with enterprise service repository to access enterprise services is in the distributed system. Here application process component 154 is designated as XY, referring back to FIG. 1, could be sales, planning, accounting or execution. PC process fulfillment includes business process object (BPO) 142 order and BPO fulfillment order 144 and a process handling engine 146. BPO fulfillment order 144 generates fulfillment associated documents that may be passed over the point to point link to another constituent that may handle other aspects of the fulfillment process as explained in more detail below. AP foundation 150 provides various resources that may be used by PC process fulfillment 152 executing the process at runtime.

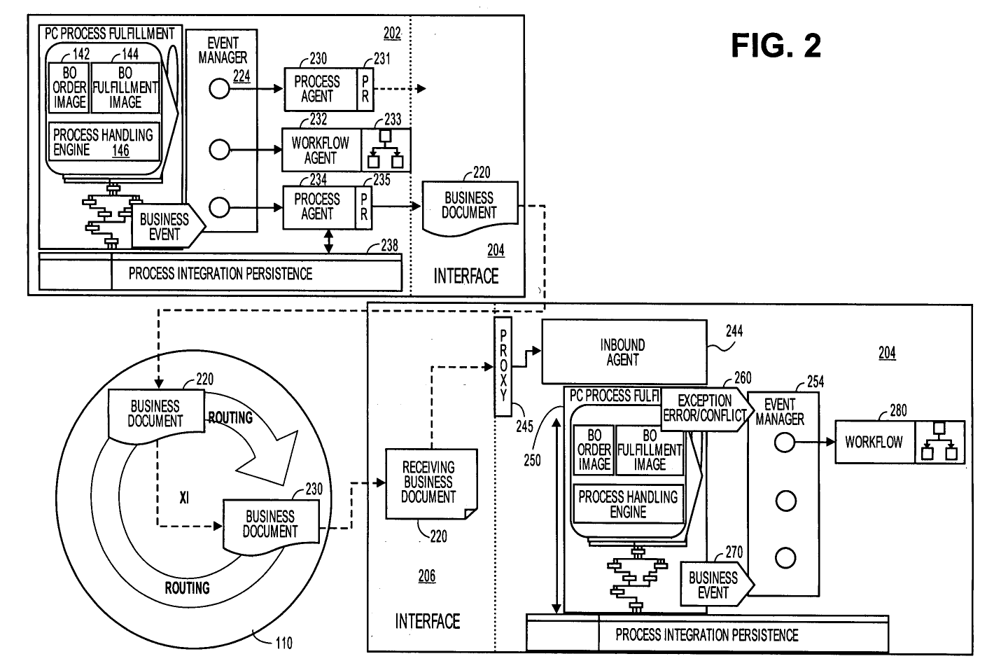

FIG. 2 is a block diagram of partial process execution during runtime in one embodiment of the invention. A business object image 142 and a business object fulfillment image 144 are used by process handling engine 146 to generate a business event 218. Business event 218 is routed to event manager which identifies an event consumer for the event. The event may go to a process agent 230 with proxy 231 which may send monitoring information back to the central instance, here the integration systems (not shown). The event may also be sent to a work flow agent 232 to be used in a work flow 233. Additionally, the event may be sent to process agent 234 with proxy 235 which in this example forwards a business document 220 through interface 204 over a point to point link using exchange infrastructure 110 to interface 206 of constituent 204. The document may also be persisted locally to constituent 202 using process integration persistence layer 238. In some embodiments, the business event may be routed by the event monitor to more or fewer event consumers.

Business document 220 is received over the point to point link at proxy 245 for inbound agent 244. Inbound agent forwards the business document to PC process fulfillment 250, which has the portion of the fulfillment process relevant to constituent 204. That relevant portion will process the incoming business document locally, possibly generating an exception 260 or business event 270. In either case, that is passed to the event manager 254 where it may be used in work flow 280 as appropriate or provided to one or more other event consumers.

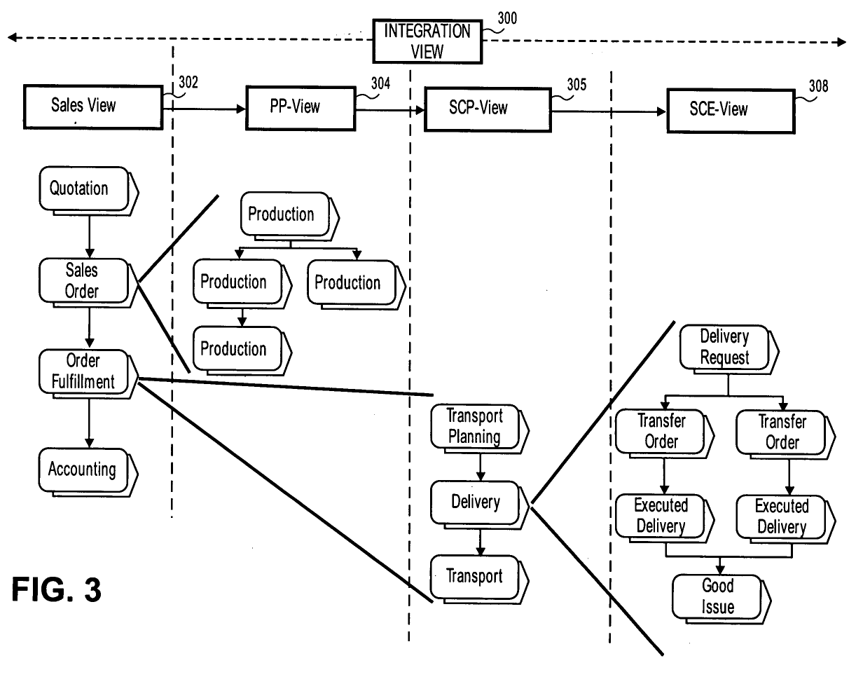

FIG. 3 shows the view of various constituents in one embodiment of the invention. For example, sales view 302 has a view of quotation sales order, order fulfillment, and accounting. However, production planning view 304 has a view of production and the various production related functions. Similarly, supply chain planning view 305 has a view of transport planning delivery and transport. This reflects delegation of order fulfillment tasks from the sales constituent to the planning constituent (as shown in FIG. 1). Referring back to FIG. 1, the planning constituent would have both production planning view 304 and supply chain planning view 305. Supply chain execution view 308 deals with delivery as a further delegation from the planning constituent to the execution constituent. Integration view 300 is the integration of all the other views. This is used for effective monitoring of the overall process during runtime.

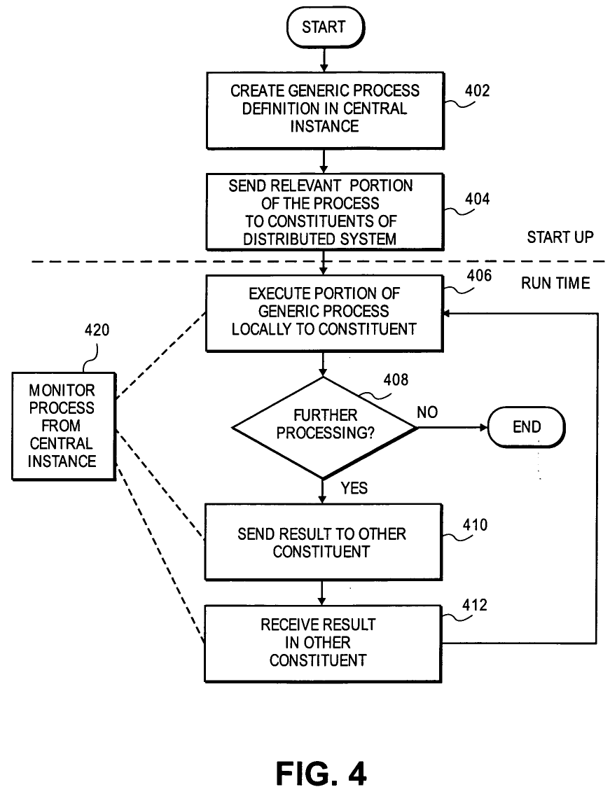

FIG. 4 is a flow diagram of operation of system of one embodiments of the invention. During startup or initialization, at block 402, a central instance creates generic process definition. In one embodiment, the generic definition may be of a fulfillment process. At block 404, still during initialization, central instance sends over portions of the process definition to constituents of the distributed system. In one embodiment, a portion of the process definition may be sent as metadata over a point to point link between the central instance and each constituent.

During runtime, the constituent having received a relevant portion, executes the relevant portion locally to the constituent at block 406, a determination is made at 408 if further processing is required. If required, the first constituent may pass the result to another constituent at block 410. This may be done by sending over a point to point asynchronous link or using any other messaging protocol suitable for conveying such results. When the other constituent receives the result at block 412, the receiving constituent executes the relevant portion of the generic process locally to that constituent at block 406. Throughout the runtime process, the central instance 420 monitors the process and maintains a record of that monitoring.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cares, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
defining at a central component a genericized process to be performed by a plurality of constituents of a distributed system;
communicating a relevant portion of the genericized process to each constituent; and
executing each portion of the process locally to the constituent at runtime; and
communicating process results directly between constituents.

2. The method of claim 1 further comprising:
modifying the portion of the genericized process locally to the system of the plurality.

3. The method of claim 1 wherein communicating a relevant portion comprises:
sending metadata describing the portion of the process over a point-to-point link between the central component and the constituent.

4. The method of claim 1 wherein communicating process results comprises:
transmitting an asynchronous message over a point-to-point limit between constituents.

5. The method of claim 1 further comprising:
instantiating a process fulfillment component in each constituent.

6. A system comprising:
an integration component to define a process;
a plurality of application components to receive and locally execute a portion of a definition of the process from the integration component; and
a messaging infrastructure to permit asynchronous communication between the application components of the plurality.

7. The system of claim 6 wherein the integration component comprises:
a monitoring module to monitor the process executed by the application components at runtime.

8. The system of claim 7 wherein the monitoring module retains a complete view of the process.

9. The system of claim 6 wherein the process is a fulfillment process and wherein the plurality of application components include at least two of a planning component; a sales component; a financial component; a production component; and an execution component.

10. They system of claim 6 wherein each component comprises:
an interface to the messaging infrastructure.

11. A machine-accessible medium containing instructions that when executed cause a machine to:
define at a central component a genericized process to be performed by a plurality of constituents of a distributed system;
communicate a relevant portion of the genericized process to each constituent; and
execute each portion of the process locally to the constituent at runtime; and
communicate process results directly between constituents.

12. The machine accessible medium of claim 11, further comprising instructions causing the machine to:
modify the portion of the genericized process locally to the system of the plurality.

13. The machine accessible medium of claim 11 wherein the instructions causing the machine to communicate the relevant portion comprise instructions causing the machine to:
send metadata describing the portion of the process over a point-to-point link between the central component and the constituent.

14. The machine accessible medium of claim 11 wherein the instructions causing the machine to communicate process results comprise instructions causing the machine to:
transmit an asynchronous message over a point-to-point limit between constituents.

15. The machine accessible medium of claim 11 further comprising instructions causing the machine to:
instantiate a process fulfillment component in each constituent.
